(19) United States
(12) Patent Application Publication
(10) Pub. No.: US 2006/0007474 A1
(43) Pub. Date: Jan. 12, 2006

(54) System and method for routing document processing operations

(76) Inventors: Brenda F. Daos, Mission Viejo, CA (US); Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/888,906

(22) Filed: Jul. 9, 2004

(51) Int. Cl. G06F 15/00

(52) U.S. Cl. 358/1.15

(57) ABSTRACT

This invention is directed to a system and method for routing electronic document processing operations. More particularly, this invention is directed to a system and method for routing document processing operations such that one job in a processing queue that is incapable of being processed does not stop other jobs in the queue from being processed.

### BACKGROUND OF THE INVENTION

This invention is directed to a system and method for routing electronic document processing operations. More particularly, this invention is directed to a system and method for routing document processing operations such that one job in a processing queue that is incapable of being processed does not stop other jobs in a queue from being processed.

Typically, in office environments or other environments in which many users share a document processing device, several processing jobs may be in the queue at the same time for processing. If one of the jobs in the processing queue is not able to be processed for some reason, such as for insufficient resources, as in insufficient amount of the required paper, time or finishing supplies, the remaining processing jobs in the queue are prevented from being processed as well. The problem with the processing job must be detected and then corrected before that job and the remaining jobs in the queue may be processed. Often the problem requires a manual deletion of the job or a manual reboot of the document processing device. In such a situation, a user or appropriate administrator must first notice the error, and then physically interract with the document processing device to correct the problem or eliminate the job from the queue. This results in lost time in processing the remaining jobs as these jobs cannot be processed until the error is corrected, which frustrates the users of the document processing device as they must wait for their processing jobs.

There is a need for a system and method for routing document processing operations such that one job in a processing queue that is incapable of being processed, either temporarily or indefinitely, does not stop other jobs in the queue from being processed.

### SUMMARY OF THE INVENTION

In accordance with the present invention, there is provided a system and method for routing document processing operations.

Further, in accordance with the present invention, there is provided a system and method for routing document processing operations wherein one job in a processing queue that is incapable of being processed, either temporarily or indefinitely, does not stop other jobs in the queue from being processed.

Further, in accordance with the present invention, there is provided a system and method for routing document processing operations which decreases the time for processing a plurality of processing jobs when one job is incapable of being processed, and reduces the frustration of associated users of the multifunctional peripheral device processing the jobs.

Still further, in accordance with the present invention, there is provided a system for routing document processing operations comprising means adapted for receiving a signal representative of a plurality of document processing operations and means adapted for receiving an exception control signal representative of a specified document processing operation of the plurality thereof that is currently incapable of complete processing. The system further comprises supervisory control signal generation means adapted for generating a supervisory control signal, which supervisory control signal intercedes with the specified document processing operation so as to remove the specified document processing operation impediment to processing of remaining document processing operations of the plurality thereof, and operational control signal generation means adapted for generating an operational control signal to control the specified document processing after receipt of the exception signal. The document processing operations preferably include printing, scanning, facsimile, copying, and optical character recognition operations.

In a preferred embodiment, the system further comprises routing signal generation means adapted for generating a routing signal, wherein the routing signal includes data representative of a selected routing of document data associated with the specified document processing operation. Preferably, the document data is routed to a storage medium, such as holding queue or temporary storage means.

In a preferred embodiment, the system further comprises means adapted for receiving additional processing information related to the specified document processing operation. In one embodiment, the additional processing information includes information related to deleting the specified document processing operation from further document processing operations. In another embodiment, the additional processing information includes information related to altering the specified document processing operation in order complete processing.

Preferably, the system also includes timer means adapted for generating a timeout signal representative of a duration of time after at least one of generation of the routing signal and receipt of additional processing information, and means adapted for generating the operational control signal in accordance with the timeout signal. The system also preferably includes means adapted for sending a notification and for logging data in the event that one of the jobs is incapable of being processed.

Still further, in accordance with the present invention, there is provided a method for routing document processing operations comprising the steps of receiving a signal representative of a plurality of document processing operations and receiving an exception control signal representative of a specified document processing operation of the plurality thereof that is currently incapable of complete processing. The method further comprises the steps of for generating a supervisory control signal, which supervisory control signal intercedes with the specified document processing operation so as to remove the specified document processing operation impediment to processing of remaining document processing operations of the plurality thereof, and generating an operational control signal to control the specified document processing after receipt of the exception signal. The document processing operations preferably include printing, scanning, facsimile, copying, and optical character recognition operations.

In a preferred embodiment, the method comprises the step of generating a routing signal, wherein the routing signal includes data representative of a selected routing of document data associated with the specified document processing operation. Preferably, the document data is routed to a storage medium, such as holding queue or temporary storage means.

In a preferred embodiment, the method further comprises the step of receiving additional processing information related to the specified document processing operation. In one embodiment, the additional processing information includes information related to deleting the specified document processing operation from further document processing operations. In another embodiment, the additional processing information includes information related to altering the specified document processing operation in order complete processing.

Preferably, the method further includes the step of generating a timeout signal representative of a duration of time after at least one of generation of the routing signal and receipt of additional processing information, and means adapted for generating the operational control signal after in accordance with the timeout signal. The method also preferably includes sending a notification and logging data in the event that one of the jobs is incapable of being processed.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flow chart illustrating the method according to the present invention; and

FIG. 3 is a flow chart illustrating the process for routing or handling of a job that is incapable of being processed.

### DETAILED DESCRIPTION OF THE PREFERRED EMBODIMENT

This invention is directed to a system and method for routing document processing operations. More particularly, this invention is directed to a system and method for routing document processing operations wherein one job in a processing queue that is incapable, either temporarily or indefinitely, of being processed does not stop other jobs in the queue from being processed.

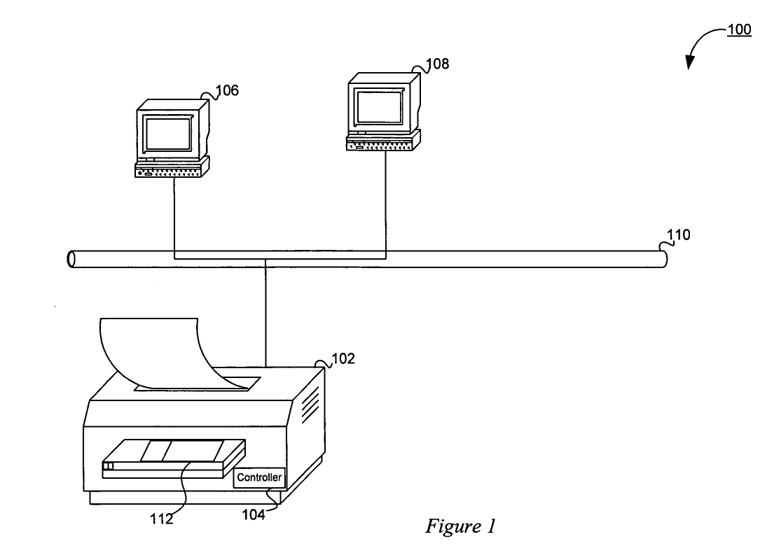

Referring to FIG. 1, there is shown a suitable system 100 for routing document processing operations according to the present invention. The system 100 comprises a document processing device 102. The document processing device 102 of system 100 includes a controller 104, typically comprising a processor component, associated memory and a communications component. The controller 104 functions to control the document processing device 102, directing the document processing device 102 operations and enabling communications between the document processing device 102 and other devices. Preferably, the document processing device is a printing device, a copying device, a scanning device, a facsimile, or a multifunctional peripheral device.

For example, as shown in FIG. 1, the system 100 resides on a computer network 110, allowing multiple computers 106, 108 to communicate and use the capabilities of the document processing device 102. The network 110 is suitably any suitable network known in the art, for example and without limitation, Ethernet, Token Ring, or the Internet. The computers 106 and 108 transmit data to the document processing device 102 through the controller 104 over the computer network 110. It will be appreciated by those skilled in the art that the document processing device 102 need not be coupled to the computer network 110, but rather is suitably in a stand-alone mode, i.e. connected to a single computer. The skilled artisan will understand that such a stand-alone configuration will not affect the operation of the present invention with respect thereto. Those skilled in the art will appreciate that the document processing device 102 is suitably any document processing device known in the art, including but not limited, for example, the Toshiba e-Studio Series Controller.

The document processing device is in data communication with an associated user interface 112 by which an associated user requests document processing operations and selects the parameters associated therewith. Preferably, the user interface preferably includes a display means for displaying information related to document processing operations. In one embodiment, the user interface is a display means or monitor attached to or associated with the document processing device wherein the user uses the interface to access or modify the information about the document processing operations. In another embodiment, the user accesses or modifies such information remotely via a remote user interface, such as via a web administrator, connected to the document processing device via any suitable means. It will be appreciated that viable user interfaces suitably take various forms, such as touch screen, keypads, pen input, and the like.

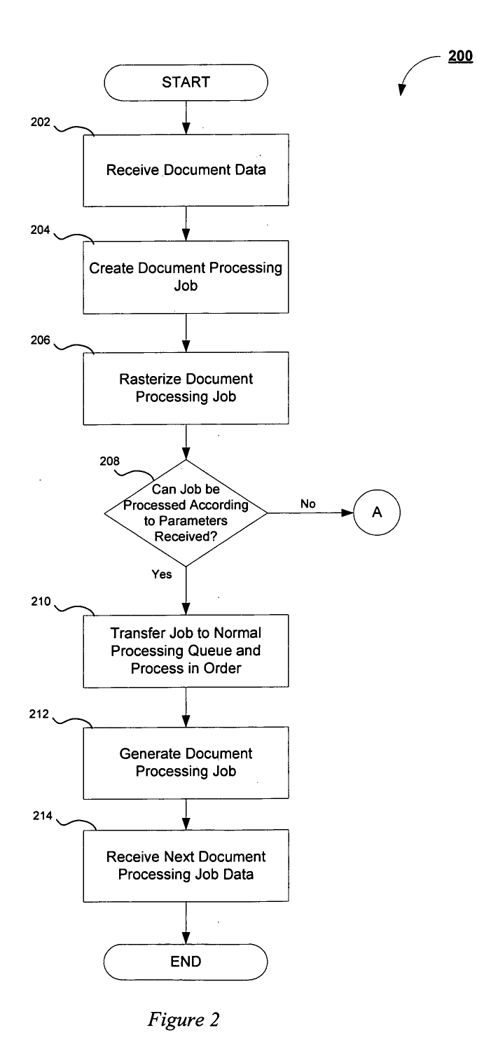

FIG. 2 is a flowchart 200 illustrating the method for routing document processing operations according to the present invention. At 202, a document processing job is received at the document processing device via any suitable means known in the art. Preferably, the document data is received at a spooling means within the document processing device upon the request from the associated user for generating the document. Preferably, the parameters for generating the document and information related to the document processing operation are also transmitted to the document processing device.

At 204, the document processing job is created via any suitable means. Preferably, the document processing job is created by job managing means within the controller in the document processing device. At 206, the document file is prepared for generating via any suitable means. Preferably, the document file is rasterized by a RIP manager means within the document processing device.

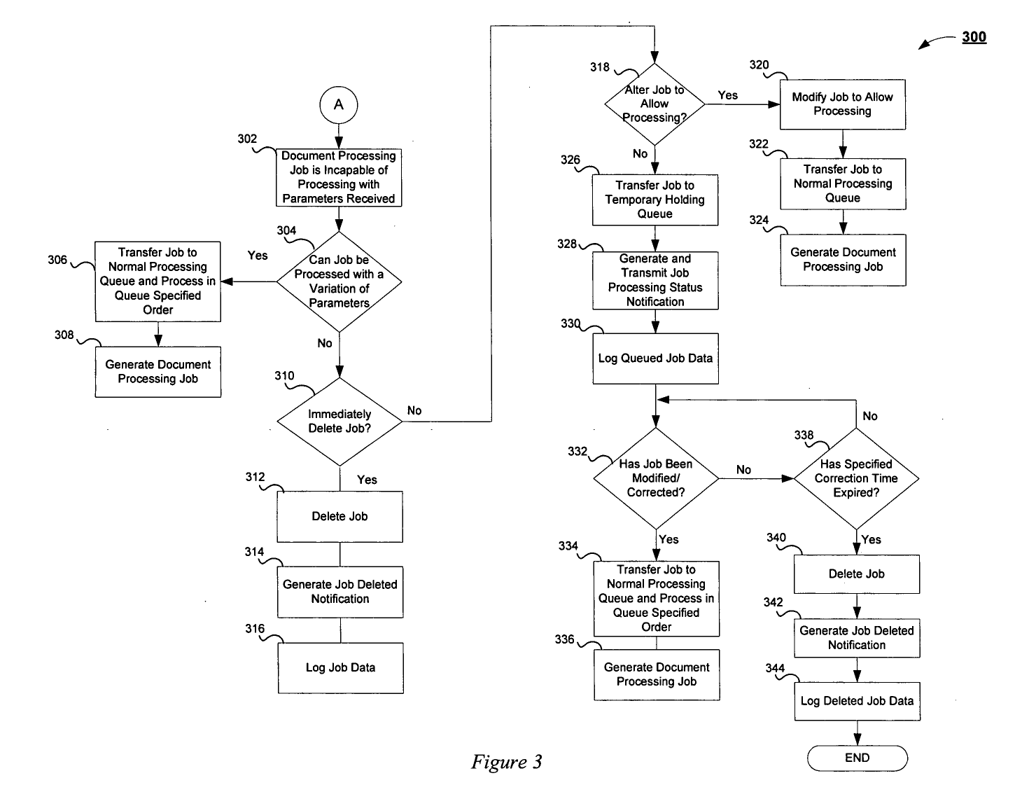

At 208, a determination is made via any suitable means as will be readily understood by one of ordinary skill in the art whether the document processing job is capable of being processed according to the parameters as received. (How will this be done?). Such determination is preferably performed without any user intervention or interaction. If the document processing job is incapable of being processed, flow proceeds to 302 as shown in FIG. 3 and described in detail below.

If the document processing job is capable of being processed, flow proceeds to 210, wherein the document processing job is transferred to a normal processing queue and processed in the order specified in the queue. At 212, the document processing job is suitably generated, and the flow proceeds to 214 wherein the document processing device proceeds to handling the next document processing job.

FIG. 3 is a flowchart illustrating the process for routing or handling a document processing job that is incapable of currently being processed. A job is incapable of being processed for a variety of reasons, including, but not limited to, the document processing device does not have the proper job resources, the document processing job did not have the proper authorization for processing, or the user requesting the job did not have the proper authorization for requesting such a job.

At 302, the document processing device or system has determined that the document processing job is incapable of being processed according to the parameters as received. Flow then proceeds to 304, wherein a determination is made as to whether the job is able to be processed with a variation in the parameters as received, such as on different paper or without finishing operations. In one embodiment, the user requesting the job suitably instructs the system to process the job if possible with such variations. Such instructions are received via any suitable means in the art, such as when selecting the parameters associated with the job.

If the job is able to processed, although not as according to the parameters as received, flow proceeds to 306, wherein the document processing job is transferred to a normal processing queue and processed in the order specified in the queue. At 308, the document processing job is generated.

If the job is not able to be processed, flow proceeds to 310, wherein a determination is made whether the job is to be immediately deleted. In one embodiment, the user requesting the job suitably instructs the system to delete immediately any jobs that cannot be processed. Such instructions are received such as when selecting the parameters associated with the job. In another embodiment, a system administrator or other authorized user sets the parameters or program for the system such that any job or selected jobs that cannot be processed is immediately deleted.

In the event the job is to be immediately deleted, flow proceeds to 312, wherein the job is deleted. At 314, a notification is generated that the job was not able to be processed and was deleted. The notification is preferably transmitted to at least one of the user and a system administrator. At 316, data relating to the job and that the job is not able to be processed is logged. Preferably, the data is logged in a database or other storage medium associated with or connected to the document processing device.

If the job is not be immediately deleted, flow proceeds to 318, wherein a determination is made as to whether the job is to be altered to allow processing. In one embodiment, the user requesting the job suitably instructs the system to process the job if possible with modifications. Such instructions are suitably received when selecting the parameters associated with the job.

In the event that it is determined that the job is to be altered or modified to allow processing, flow proceeds to 320, wherein the job is modified accordingly to allow processing. Job modification instructions are suitably received from the user if requested or as part of the parameters selected for the processing job, via a system administrator, or via the parameters set for the document processing device. Flow then proceeds to 322, wherein the document processing job is transferred to a normal processing queue and processed in the order specified in the queue. At 324, the document processing job is generated.

In the event that the job is not able to be altered or modified to allow processing, flow proceeds to 326, wherein the job is moved to a storage medium or temporary holding queue. At 328, a notification is generated and preferably transmitted to at least one of the associated user or system administrator notifying such person that the job is incapable of being processed and is in the holding queue. The user or system administrator then is able to modify the job accordingly to allow processing or correct the error in the document processing device to allow processing. The job is held in the holding queue for a specified amount of time. Such time is suitably determined by the system administrator or authorized user when setting the parameters for the document processing device.

In a preferred embodiment, data relating to the job held in the holding queue is logged as shown at 330. Preferably, the data is logged in a database or other storage medium associated with or connected to the document processing device. Such log is suitably viewed or displayed by the user or system administrator. In the event one of the jobs in the holding queue is a confidential job, the user must have the proper authorization to view the details of such job.

At 332, a determination is made whether the job has been modified or the error corrected in the document processing device such that the job is able to be processed. If the job is able to be processed, flow proceeds to 334, wherein the document processing job is transferred to a normal processing queue and processed in the order specified in the queue. At 336, the document processing job is generated.

If the job has not been modified or the error corrected in the document processing device, then flow proceeds to 338, wherein a determination is made whether the specified time has expired for correcting the problem. If time has not expired, flow returns to 332 to await for the user to correct the error or modify the job for processing.

If the time has expired, flow proceeds to 340 wherein the job is deleted. At 342, a notification is generated that the job was not able to be processed and was deleted. The notification is preferably transmitted to at least one of the user and a system administrator. At 344, data relating to the job and that the job is not able to be processed is advantageously logged. Preferably, the data is logged in a database or other storage medium associated with or connected to the document processing device.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A system for routing of document processing operations comprising:
means adapted for receiving a signal representative of a plurality of document processing operations;
means adapted for receiving an exception control signal representative of a specified document processing operation of the plurality thereof that is currently incapable of complete processing;
supervisory control signal generation means adapted for generating a supervisory control signal, which supervisory control signal intercedes with the specified document processing operation so as to remove the specified document processing operation impediment to processing of remaining document processing operations of the plurality thereof; and
operational control signal generation means adapted for generating an operational control signal to control the specified document processing after receipt of the exception signal.

2. The system for routing of document processing operations of claim 1 further comprising routing signal generation means adapted for generating a routing signal, in accordance with a received exception control signal, wherein the routing signal includes data representative of a selected routing of document data associated with the specified document processing operation.

3. The system for routing of document processing operations of claim 2 wherein the document data is routed to a storage medium.

4. The system for routing of document processing operations of claim 2 further comprising means adapted for receiving additional processing information related to the specified document processing operation, wherein the operational control signal is generated in accordance therewith.

5. The system for routing of document processing operations of claim 4 wherein the additional processing information includes information related to deleting the specified document processing operation from further document processing operations, wherein the operation control signal is generated in accordance therewith.

6. The system for routing of document processing operations of claim 4 wherein the additional processing information includes information related to altering the specified document processing operation in order complete processing, wherein the operation control signal is generated in accordance therewith.

7. The system for routing of document processing operations of claim 4 further comprising timer means adapted for generating a timeout signal representative of a duration of time after at least one of generation of the routing signal and receipt of additional processing information, and means adapted for generating the operational control signal in accordance with the timeout signal.

8. The system for routing of document processing operations of claim 1 further comprising notification signal generation means for generating a notification signal, in accordance with a received exception control signal, wherein the notification signal includes data representative of a notification that a specified document processing operation of the plurality thereof that is currently incapable of complete processing.

9. The system for routing document processing operations of claim 1 further comprising logging means adapted for logging data in accordance with the received exception control signal.

10. The system for routing document processing operations of claim 1 wherein the document processing operations include printing, scanning, facsimile, copying, and optical character recognition operations.

11. A method for routing of document processing operations comprising the steps of:
receiving a signal representative of a plurality of document processing operations;
receiving an exception control signal representative of a specified document processing operation of the plurality thereof that is currently incapable of complete processing;
generating a supervisory control signal, which supervisory control signal intercedes with the specified document processing operation so as to remove the specified document processing operation impediment to processing of remaining document processing operations of the plurality thereof; and
generating an operational control signal to control the specified document processing after receipt of the exception signal.

12. The method for routing of document processing operations of claim 111 further comprising the step of generating a routing signal, in accordance with a received exception control signal, wherein the routing signal includes data representative of a selected routing of document data associated with the specified document processing operation.

13. The method for routing of document processing operations of claim 12 wherein the document data is routed to a storage medium.

14. The method for routing of document processing operations of claim 12 further comprising the step of receiving additional processing information related to the specified document processing operation, wherein the operational control signal is generated in accordance therewith.

15. The method for routing of document processing operations of claim 14 wherein the additional processing information includes information related to deleting the specified document processing operation from further document processing operations, wherein the operation control signal is generated in accordance therewith.

16. The method for routing of document processing operations of claim 14 wherein the additional processing information includes information related to altering the specified document processing operation in order complete processing, wherein the operation control signal is generated in accordance therewith.

17. The method for routing of document processing operations of claim 14 further comprising the step of generating a timeout signal representative of a duration of time after at least one of generation of the routing signal and receipt of additional processing information, and means adapted for generating the operational control signal in accordance with the timeout signal.

18. The method for routing of document processing operations of claim 11 further comprising the step of generating a notification signal, in accordance with a received exception control signal, wherein the notification signal includes data representative of a notification that a specified document processing operation of the plurality thereof that is currently incapable of complete processing.

19. The method for routing document processing operations of claim 11 further comprising the step of logging data in accordance with the received exception control signal.

20. The method for routing document processing operations of claim 11 wherein the document processing operations include printing, scanning, facsimile, copying, and optical character recognition operations.

21. A computer-readable medium of instructions for routing of document processing operations comprising:
instructions for receiving a signal representative of a plurality of document processing operations;
instructions for receiving a exception control signal representative of a specified document processing operation of the plurality thereof that is currently incapable of complete processing;
instructions for generating a supervisory control signal, which supervisory control signal intercedes with the specified document processing operation so as to remove the specified document processing operation impediment to processing of remaining document processing operations of the plurality thereof; and
instructions for generating an operational control signal to control the specified document processing after receipt of the exception signal.

22. The computer-readable medium of instructions for routing of document processing operations of claim 21 further comprising instructions for generating a routing signal, in accordance with a received exception control signal, wherein the routing signal includes data representative of a selected routing of document data associated with the specified document processing operation.

23. The computer-readable instructions for routing of document processing operations of claim 22 further comprising instructions for receiving additional processing information related to the specified document processing operation, wherein the operational control signal is generated in accordance therewith.

24. The computer-readable instructions for routing of document processing operations of claim 23 further comprising instructions for generating a timeout signal representative of a duration of time after at least one of generation of the routing signal and receipt of additional processing information, and means adapted for generating the operational control signal in accordance with the timeout signal.

25. The computer-readable instructions for routing of document processing operations of claim 21 further comprising instructions for generating a notification signal, in accordance with a received exception control signal, wherein the notification signal includes data representative of a notification that a specified document processing operation of the plurality thereof that is currently incapable of complete processing.

26. The computer-readable instructions for routing document processing operations of claim 21 wherein the document processing operations include printing, scanning, facsimile, copying, and optical character recognition operations.

27. A computer-implemented method for routing of document processing operations comprising the steps of:
receiving a signal representative of a plurality of document processing operations;
receiving a exception control signal representative of a specified document processing operation of the plurality thereof that is currently incapable of complete processing;
generating a supervisory control signal, which supervisory control signal intercedes with the specified document processing operation so as to remove the specified document processing operation impediment to processing of remaining document processing operations of the plurality thereof; and
generating an operational control signal to control the specified document processing after receipt of the exception signal.

28. The computer-implemented method for routing of document processing operations of claim 27 further comprising the step of generating a routing signal, in accordance with a received exception control signal, wherein the routing signal includes data representative of a selected routing of document data associated with the specified document processing operation.

29. The computer-implemented method for routing of document processing operations of claim 28 further comprising the step of receiving additional processing information related to the specified document processing operation, wherein the operational control signal is generated in accordance therewith.

30. The computer-implemented method for routing of document processing operations of claim 29 further comprising the step of generating a timeout signal representative of a duration of time after at least one of generation of the routing signal and receipt of additional processing information, and means adapted for generating the operational control signal in accordance with the timeout signal.

31. The computer-implemented method for routing of document processing operations of claim 27 further comprising the step of generating a notification signal, in accordance with a received exception control signal, the notification signal including data representative of a notification that a specified document processing operation of the plurality thereof that is currently incapable of complete processing.

32. The computer-implemented method for routing document processing operations of claim 27 wherein the document processing operations include printing, scanning, facsimile, copying, and optical character recognition operations.
